(19) United States
(12) Patent Application Publication
(10) Pub. No.: US 2008/0258621 A1
(43) Pub. Date: Oct. 23, 2008

(54) Plasma display panel

(76) Inventor: Jung-tae Park, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/010,248

(22) Filed: Jan. 23, 2008

(30) Foreign Application Priority Data
Apr. 23, 2007 (KR) 10-2007-0039339

(51) Int. Cl. H01J 17/49

(52) U.S. Cl. 313/582

(57) ABSTRACT

A plasma display panel includes a front substrate, a rear substrate positioned in parallel to the front substrate to form a discharge space therebetween, a plurality of barrier rib units disposed between the front substrate and the rear substrate to partition discharge cells, and a plurality of discharge electrodes to discharge the discharge cells. Each barrier rib unit may include a rib in a horizontal direction and a rib in a vertical direction so that a thickness of the barrier rib in the horizontal direction is larger than a thickness of the barrier rib in the vertical direction.

### BACKGROUND OF THE INVENTION

1. Field of the Invention

Example embodiments relate to a plasma display panel and, more particularly, to a plasma display panel for increasing bright room contrast in a high-resolution plasma display.

2. Description of the Related Art

A plasma display panel (PDP) may be a display device, e.g., a flat panel type, formed by providing electrodes on one side or both sides of two substrates opposed to each other, and sealing the panel, after inserting a discharge gas into a space therebetween. Accordingly, PDPs may be a thinner device than a cathode ray tube (CRT) display device, while at the same time implementing a large screen with relatively small volume. Further, PDPs may not need to use active elements, (e.g., transistors and the like), as used in liquid crystal displays (LCDs), in order to provide wide viewing angle and high brightness.

PDPs may include a plurality of pixels for displaying a screen arranged in a matrix. Each pixel may be driven in a passive matrix scheme, i.e., a voltage may be applied to an electrode without an active element for driving. Further, the PDPs may be divided into a DC type and an AC type according to types of voltage signals for driving each electrode. The PDPs may also be divided into a facing discharge structure and a surface discharge structure according to a disposing structure of two electrodes to which the discharge voltage is applied.

In the DC type, the electrodes may be exposed to the discharge space so that current may directly flow from the discharge space to the electrodes. However, it may be difficult to form a separate resistor connected to the electrode for protecting the electrodes and control the current in the DC type. In the AC type, the electrodes may be covered with a dielectric layer to produce electrostatic capacitance, so that current flowing to the electrodes may be limited and the electrode signals may be easily protected from ion impact at the time of discharge. As a result, the life span of the electrodes may be extended.

Further, the electrodes may typically be formed in substrates (e.g., a rear substrate and a front substrate) as a common three-electrode surface discharge, e.g., an address electrode may be formed on the rear substrate, and a sustain electrode and a scan electrode may alternately be formed perpendicularly to the address electrode on the front substrate.

Further, in a high definition (HD) display, intervals between the unit pixels may be required to be close, so as to produce a high quality standard. However, in a high resolution PDP, a ratio of non-light emitting region may be large as a size of each discharge cell becomes small, which may deteriorate the brightness of the image.

Accordingly, if the size of the barrier ribs of each discharge cell is small, an aperture ratio of the cell may become high. Thus, this may deteriorate a discharge property of the discharge cell, as well, as raise a reflective brightness of the panel, i.e., degrade the bright room contrast of the panel. Further, when reducing the size of the barrier ribs of each discharge cell, there may be limitations in securing an efficiency of manufacturing process and/or providing mechanical strength of a structure.

### SUMMARY OF THE INVENTION

Example embodiments are therefore directed to a display device, which may substantially overcome one or more of the problems due to the limitations and disadvantages of the related art.

It is therefore a feature of example embodiments to provide a PDP capable of increasing bright room contrast while securing sufficient aperture ratio.

It is therefore another feature of example embodiments to provide an efficient structure of barrier ribs.

It is therefore another feature of example embodiments to provide a high resolution PDP having improved aperture ratio, bright room contrast and/or discharge efficiency.

At least one of the above and other features of example embodiments may be to provide to a plasma display panel, including a front substrate, a rear substrate positioned in parallel to the front substrate to form a discharge space therebetween, a plurality of barrier rib units disposed between the front substrate and the rear substrate to partition discharge cells, and a plurality of discharge electrodes to discharge the discharge cells. Each barrier rib unit may include a rib in a horizontal direction and a rib in a vertical direction so that a thickness of the barrier rib in the horizontal direction is larger than a thickness of the barrier rib in the vertical direction.

The thickness of the barrier rib in the horizontal direction may be approximately 1.3 to 2.5 times to that of the barrier rib in the vertical direction. The discharge electrodes may include an X-electrode extending parallel to the horizontal direction and a Y-electrode extending parallel to the horizontal direction. The X-electrode may be positioned on the front substrate over the barrier rib in the horizontal direction. The X-electrode may be positioned over the discharge cell region around the barrier rib in the horizontal direction. The Y-electrode may be positioned on the front substrate on an upper portion of the barrier rib in a horizontal direction. The Y-electrode may be positioned over the discharge cell region around the barrier rib in the horizontal direction. The X and Y electrodes may be made of metal.

The plasma display panel may include transparent electrodes formed to extend from the X and Y electrodes and toward the discharge cell. The plasma display panel may include a pair of barrier rib units to form a space therebetween to form a double-barrier rib. The plasma display panel may include a light shielding film shielding a passage of light provided on an upper portion of the space between the pair of barrier ribs in the horizontal direction. The plasma display panel may include an aperture ratio of the discharge cell 65% or more. The plasma display panel may include a color of the barrier rib unit and a color of a dielectric layer formed on the front substrate having a complementary color relationship. The plasma display panel may include a photoluminescent material in the barrier rib unit.

The plasma display panel may be a three-electrode surface discharge type structure with an XXYY type electrode arrangement. The plasma display panel may be a three-electrode surface discharge type structure with an XYXY type electrode arrangement.

### BRIEF DESCRIPTION OF THE DRAWINGS

The above and other features and advantages of example embodiments will become more apparent to those of ordinary skill in the art by describing in detail example embodiments thereof with reference to the attached drawings, in which:

FIG. 1 illustrates a perspective view of an arrangement of a barrier rib unit of a three-electrode surface discharge cell according to an example embodiment;

FIG. 2 illustrates a plan view of a relationship of a line width of horizontal/vertical barrier ribs of the PDP according to an example embodiment;

FIG. 3 illustrates a plan view of a barrier rib unit and a discharge electrode applied to a three-electrode surface discharge cell having an XXYY type electrode structure in accordance to an example embodiment;

FIG. 4 illustrates a plan view of a barrier rib unit and a discharge electrode applied to a three-electrode surface discharge cell having an XYXY type electrode structure in accordance to another example embodiment; and

FIG. 5 illustrates a graph of a ratio of a peak brightness and a right room contrast for a line width (A) of a horizontal barrier rib and a line width (B) of a vertical barrier rib, in the PDP having the structure as shown in FIG. 3.

### DETAILED DESCRIPTION OF THE INVENTION

Korean Patent Application No. 10-2007-0039339, filed on Apr. 23, 2007, in the Korean Intellectual Property Office, and entitled: “Plasma Display Panel,” is incorporated by reference herein in its entirety.

Example embodiments will now be described more fully hereinafter with reference to the accompanying drawings. The invention may, however, be embodied in different forms and should not be construed as limited to the embodiments set forth herein. Rather, these example embodiments are provided so that this disclosure will be thorough and complete, and will fully convey the scope of the invention to those skilled in the art.

In order to secure sufficient aperture ratio and raise bright room contrast of a PDP, example embodiments provide a structure where a line width (A) of a horizontal barrier rib may be constituted to be relatively wide and a line width (B) of a vertical barrier rib may be constituted to be relatively narrow. Further, in another example embodiment, a line width of a metal electrode may be constituted to be relatively wider on an upper width of the barrier rib.

Further, example embodiments may be applied to a high resolution PDP above a full HD (FHD) grade (e.g., in a 50-inch monitor, a precision of 1920×1080 resolution may be set to be the lowest limit; and in a 48-inch monitor, the precision of 1980×1080 resolution may be set be at 1920×1080 resolution or more). Therefore, in order to secure the sufficient aperture ratio having a smaller sized structure, a thickness of a first unit barrier rib and a second unit barrier rib in a horizontal direction forming a double-barrier rib may be approximately 1.3 to 2.5 times to that of a vertical barrier rib. Further, it may be desirable to reduce the horizontal and vertical length of each discharge cell to approximately 0.8 mm (i.e., approximately 0.726 mm in a 63-inch FHD cell pitch), and maintain the aperture ratio to be approximately 65%, or approximately 65% to 90%. Accordingly, example embodiments may have a higher precision resolution than a conventional PDP, and the inner structure may be smaller in size than that of a conventional PDP.

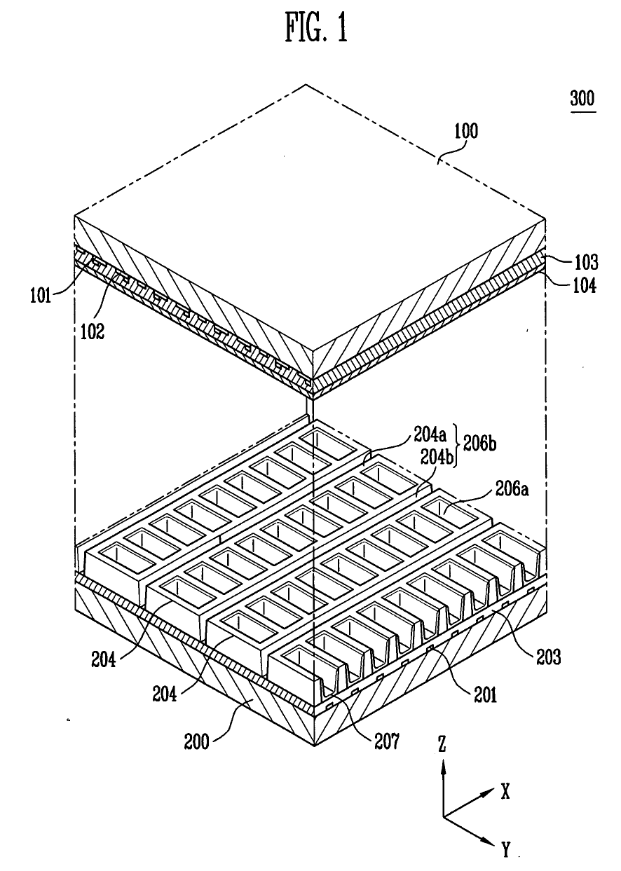

FIG. 1 illustrates a perspective view of a PDP 300 having an arrangement of a barrier rib unit 204 as a three-electrode surface discharge cell according to an example embodiment.

Referring to FIG. 1, the PDP 300 may include a front substrate 100 and a rear substrate 200 with discharge electrodes 101, 102 and 201 (e.g., a scan electrode 101, a sustain electrode 102 and an address electrode 201) therebetween. The front and rear substrates 100 and 200 may be disposed in parallel, and may face each other. Each one of the front and rear substrates 100 and 200 may be formed of a transparent substrate (e.g., a transparent glass material) including components such as, but not limited to, PbO, SiO₂, B₂O₃, etc. It should be appreciated that the components may be a mixture of PbO, SiO₂, and B₂O₃.

It should further be appreciated that the front and/or rear substrates 100 and 200 may also be formed of soda lime glass, a semi-transmissible substrate, a reflective substrate, or a colored substrate.

The front substrate 100 may further include a front dielectric layer 103 and a protective film 104. The protective film 104 may substantially cover the front dielectric layer 103. Further, the protective film 104 may prevent and/or reduce damage to the front dielectric layer 103 due to impact of cations and electrons in the front dielectric layer 103 at the time of discharge, and may increase emission of secondary electrons. The protective film 104 may be formed of magnesium oxide (MgO). However, it should be appreciated that other materials may be employed for the protective film 104.

The rear substrate 200 may further include a rear dielectric layer 203 and the barrier rib unit 204. The barrier rib unit 204 may be positioned between the front and rear substrates 100 and 200 to define discharge cells and to prevent cross talk therebetween. The barrier rib unit 204 may further include photoluminescent layers 207 (e.g., phosphor layers) disposed on inner surfaces of the discharge cells, so that voltage applied to the discharge gas may trigger ultraviolet (UV) light generation, followed by emission of visible light by the photoluminescent layers 207. The photoluminescent layer 207 may be formed on any portion of a surface of the discharge cells, e.g., an upper surface of the rear dielectric layer 203 and/or on side surfaces of the barrier ribs 204. The photoluminescent layers 207 may include a phosphor layer emitting red light, e.g., (Y,Gd)BO₃;Eu+³, a phosphor layer emitting green light, e.g., Zn₂SiO₄:Mn²⁺, and/or a phosphor layer emitting blue light, e.g., BaMgAl₁₀O₁₇:Eu²⁺.

The scan electrode 101 and the sustain electrode 102 may be disposed to be parallel on the front substrate 100, e.g., the lower surface of the front substrate 100 may be provided with the sustain discharge electrode 102 (hereinafter, referred to as ‘X-electrode’) and the scan discharge electrode 101 (hereinafter, referred to as ‘Y-electrode’) to generate a sustain discharge for displaying color per one discharge cell formed in a pair. In an example embodiment, the pair of X-Y electrodes may be formed to be substantially parallel to the barrier ribs unit 204 in a horizontal direction (e.g., in an x-axis direction) forming a double-barrier rib.

The Y-electrode 101 and the X-electrode 102 may be arranged in every discharge space 206a of each unit discharge cell. The Y-electrode 101 and the X-electrode 102 may be formed of a metal electrode made of a metal thin film having excellent conductivity, e.g., silver (Ag) and/or copper (Cu), and may include a transparent electrode made of a transparent conductive film, e.g., indium tin oxide (ITO), connected to the metal electrode.

The front dielectric layer 103 may be formed in a shape to cover the scan electrode 101 and the sustain electrode 102. The address electrode 201 may be formed on an inner surface of the rear substrate 200 in a direction (i.e., along the y-axis) intersecting with the pair of X-Y electrodes 101 and 102. The address electrode 201 may appoint the on/off of each pixel on a frame to be displayed. The address electrode 201 may be formed of a transparent conductive film, e.g., ITO and/or a conductive metal thin film, e.g., Ag, Au, Cu, etc.

The rear dielectric layer 203 may be formed to cover the address electrode 201 (hereinafter, referred to as ‘A electrode’), and may be formed of a dielectric material, e.g., PbO, B₂O₃, SiO₃, etc.

The barrier rib unit 204 may divide the PDP 300 into a discharge region 206a and a non-discharge region 206b. The discharge region 206a may mean a region where a plurality of sub-pixels R, G, and B may be formed to display a predetermined image due to the discharge, and the non-discharge region 206a may mean a region where the barrier rib unit 204 may not display an image within the PDP 300. For example, the non-discharge region 206b may be the region of an upper portion 204a of the barrier rib unit 204 and an exhaust region 204b between adjacent barrier rib units 204. As shown in FIG. 1, the barrier rib unit 204 may be formed as a double-barrier rib in a horizontal direction, so that the exhaust region 204b may be formed between first and second unit barrier ribs 204 forming the double-barrier rib. The exhaust region 204b may serve as a fluid passage of exhaust gas or discharge gas, e.g., neon (Ne), xenon (Xe), helium (He), or a combination thereof. In other words, an impurity gas filled in each sub-pixel R, G, and B may be exhausted to an external through the exhaust region 204b.

Although the example embodiments illustrate the barrier rib unit 204 being formed on the lower surface of the front dielectric layer 103 and the upper surface of the rear dielectric layer 203, it should be appreciated that auxiliary barrier ribs may be formed vertically to the first and second unit barrier ribs in order to prevent discharge and/or reinforce the strength of the PDP structure.

It should be appreciated that at least one of the front dielectric layer 103 and the barrier rib unit 204 may be colored so that the color of the barrier rib unit 204 and the color of the dielectric layer 103 formed on the front substrate 100 may have complementary color relationship (i.e., subtractive mixture).

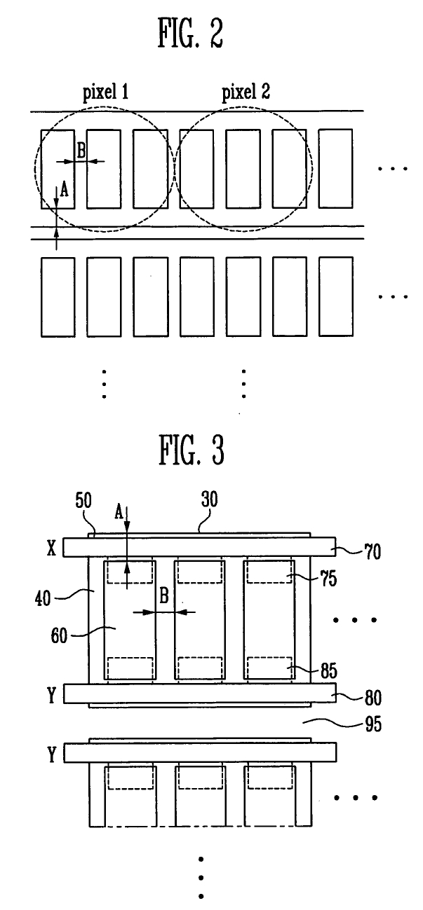

FIG. 2 illustrates a plan view of a relationship of a line width of horizontal/vertical barrier ribs of the PDP according to an example embodiment.

Referring to FIG. 2, the horizontal barrier rib may have a width A generally larger than a width B of the vertical barrier rib.

FIG. 3 illustrates an arrangement of a pair of X-Y electrodes 70 and 80 in a three-electrode discharge cells having an XXYY type electrode arrangement in accordance with an example embodiment.

Referring to FIG. 3, a barrier rib 30 may include a vertical barrier rib 40 and a horizontal barrier rib 50 to define a discharge cell 60. Further, a thickness (A) of the horizontal barrier rib 50 may be larger than a thickness (B) of the vertical barrier rib 40. The thickness (A) of the horizontal barrier rib 50 may be larger than the thickness (B) of the vertical barrier rib 40 by approximately 1.3 to 2.5 times, or approximately 1.4 to 2.5 times.

Further, the XXYY type electrode arrangement may provide a discharge electrode of a same polarity in a space 95 between two discharge cells 60 (i.e., space between the double-barrier ribs) so as to reduce the occurrence of a discharge phenomenon in the space 95.

Accordingly, the X electrode 70 and the Y electrode 80 may act as reflectors on the upper part of the barrier rib 30 in a generally horizontal direction so as to raise the aperture ratio of the discharge cell 60.

The X electrode 70 and the Y electrode 80 may be formed of a metal, e.g., silver (Ag) and/or a chromium-cobalt-chromium alloy (Cr—Co—Cr) with high conductivity.

Transparent electrodes 75 and 85 may extend from the X and Y electrodes 70 and 80 in order to raise efficiency in the discharge. Further, the transparent electrodes 75 and 85 may be formed to extend from the X and Y electrodes 70 and 80 to the discharge cell 60.

Further, a light shielding film (not shown) may be disposed on an upper part of a space 95 formed with the double-barrier rib, and thus, preventing and/or reducing reflection of external light.

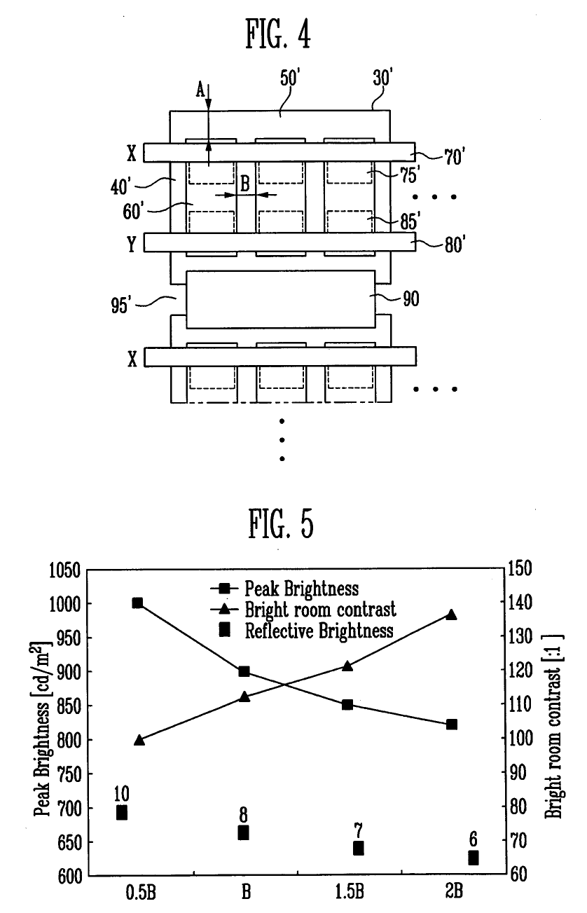

FIG. 4 illustrates an arrangement of a pair of X-Y electrodes 70′ and 80′ in a three-electrode discharge cells having an XYXY type electrode arrangement in accordance to another example embodiment.

Referring to FIG. 4, a barrier rib 30′ may include a vertical barrier rib 40 and a horizontal barrier rib 50′ to define a discharge cell 60′. Further, a thickness (A) of the barrier rib 50′ in a horizontal direction may be larger than a thickness (B) of the barrier rib 40′ in a vertical direction. The thickness (A) of the barrier rib 50′ may be larger than the thickness (B) of the barrier rib 40′ by approximately 1.3 to 2.5 times more.

However, in the XYXY type electrode arrangement, there may be a pair of X electrode 70′ and Y electrode 80′ over the discharge cells 60′ so as to reduce any potential that the discharge phenomenon may occur. Accordingly, the example embodiment as shown in FIG. 4 illustrates the X electrode 70′ and the Y electrode 80′ disposed on an upper portion of an inside of the discharge cell 60′ in order to prevent and/or reduce the discharge phenomenon in the space.

The X electrode 70′ and the Y electrode 80′ may be formed of a metal, e.g., silver (Ag) and/or a chromium-cobalt-chromium alloy (Cr—Co—Cr) with high conductivity.

Transparent electrodes 75′ and 85′ may be extended from the X and Y electrodes 70′ and 80′ in order to raise the discharge efficiency. Further, the transparent electrodes 75′ and 85′ may be formed to extend from the X and Y electrodes 70′ and 80′ to the discharge cell 60′.

Further, a light shielding film 90 may be disposed on an upper part of a space 95′ formed by the double-barrier rib and, thus, preventing and/or reducing a reflection of external light. The light shielding film 90 may further shield discharge light possibly generated in the space 95′ that may be projected to the external.

FIG. 5 illustrates a graph showing a ratio of a peak brightness and bright room contrast for a line width (A) of a horizontal barrier rib and a line width (B) of a vertical barrier rib. The right axis represents the bright room contrast, and the left axis represents the peak brightness.

As shown in the graph of FIG. 5, the bright room contrast may be improved at A≧1.3B, or at A≧1.5B. However, if A is continuously increased, the peak brightness may deteriorate and the mechanical strength or the aperture ratio of the high resolution PDP may be reduced. As a result, it may be desirable that A≧2.5B.

Example embodiments provide a PDP capable of raising bright room contrast, while providing sufficient aperture ratio.

Example embodiments provide a high resolution PDP having a barrier rib with efficient aperture ratio, bright room contrast and/or discharge efficiency.

In the figures, the dimensions of elements and regions may be exaggerated for clarity of illustration. It will also be understood that when an element is referred to as being “on”, “connected to” or “coupled to” another element it can be directly on, connected or coupled to the other element or intervening elements may be present. In contrast, when an element is referred to as being “directly on,” “directly connected to” or “directly coupled to” another element, there are no intervening elements present. Further, it will be understood that when an element is referred to as being “under” or “above” another element, it can be directly under or directly above, and one or more elements may also be present. In addition, it will also be understood that when an element is referred to as being “between” two elements, it can be the only element between the two elements, or one or more intervening element may also be present. Like numbers refer to like elements throughout. As used herein, the term “and/or” includes any and all combinations of one or more of the associated listed items.

It will also be understood that, although the terms “first”, “second”, “third” etc. may be used herein to describe various elements, structures, components, regions, layers and/or sections, these elements, structures, components, regions, layers and/or sections should not be limited by these terms. These terms are only used to distinguish one element, structure, component, region, layer and/or section from another element, structure, component, region, layer and/or section. Thus, a first element, structure, component, region, layer or section discussed below could be termed a second element, structure, component, region, layer or section without departing from the teachings of Example embodiments.

Spatially relative terms, such as “beneath,” “below,” “lower,” “above,” “upper” and the like, may be used herein for ease of description to describe one element or feature relationship to another element(s) or feature(s) as illustrated in the figures. It will be understood that the spatially relative terms are intended to encompass different orientations of the device in use or operation in addition to the orientation depicted in the figures. For example, if the device in the figures is turned over (or upside down), elements or features described as “below” or “beneath” other elements or features would then be oriented “above” the other elements or features. Thus, the Example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of Example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a front substrate;
a rear substrate positioned in parallel to the front substrate to form a discharge space therebetween;
a plurality of barrier rib units disposed between the front substrate and the rear substrate to partition discharge cells, each barrier rib unit includes a rib in a horizontal direction and a rib in a vertical direction; and
a plurality of discharge electrodes to discharge the discharge cells,
wherein a thickness of the barrier rib in the horizontal direction is larger than a thickness of the barrier rib in the vertical direction.

2. The plasma display panel as claimed in claim 1, wherein the thickness of the barrier rib in the horizontal direction is approximately 1.3 to 2.5 times to that of the barrier rib in the vertical direction.

3. The plasma display panel as claimed in claim 1, wherein the discharge electrodes include an X-electrode extending parallel to the horizontal direction and a Y-electrode extending parallel to the horizontal direction.

4. The plasma display panel as claimed in claim 3, wherein the X-electrode is positioned on the front substrate over the barrier rib in the horizontal direction.

5. The plasma display panel as claimed in claim 4, wherein the X-electrode is positioned over the discharge cell region around the barrier rib in the horizontal direction.

6. The plasma display panel as claimed in claim 4, wherein the Y-electrode is positioned on the front substrate on an upper portion of the barrier rib in the horizontal direction.

7. The plasma display panel as claimed in claim 6, wherein the Y-electrode is positioned over the discharge cell region around the barrier rib in the horizontal direction.

8. The plasma display panel as claimed in claim 4, wherein the X and Y electrodes are made of metal.

9. The plasma display panel as claimed in claim 4, further comprising transparent electrodes formed to extend from the X and Y electrodes and toward the discharge cell.

10. The plasma display panel as claimed in claim 1, wherein a pair of barrier rib units forms a space therebetween to form a double-barrier rib.

11. The plasma display panel as claimed in claim 9, wherein a light shielding film shielding a passage of light is provided over the space between the pair of barrier ribs in the horizontal direction.

12. The plasma display panel as claimed in claim 1, wherein an aperture ratio of the discharge cell is 65% or more.

13. The plasma display panel as claimed in claim 1, wherein a color of the barrier rib unit and a color of a dielectric layer formed on the front substrate form a complementary color relationship

14. The plasma display panel as claimed in claim 1, wherein the plasma display panel is a three-electrode surface discharge type structure with an XXYY type electrode arrangement.

15. The plasma display panel as claimed in claim 1, wherein the plasma display panel is a three-electrode surface discharge type structure with an XYXY type electrode arrangement.

16. The plasma display panel as claimed in claim 1, further comprising a photoluminescent material in the barrier rib unit.
